(19) United States
(12) Patent Application Publication
(10) Pub. No.: US 2005/0073596 A1
(43) Pub. Date: Apr. 7, 2005

(54) Noise removal method, storage medium having stored therein noise removal processing program and noise removing apparatus

(75) Inventor: Akihiko Takahashi, Kawasaki-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/953,411

(22) Filed: Sep. 30, 2004

(30) Foreign Application Priority Data
Oct. 2, 2003 (JP) 2003-344319

(51) Int. Cl. H04N 5/217

(52) U.S. Cl. 348/241

(57) ABSTRACT

Image data are obtained by photographing a target image containing fixed pattern noise and a noise image photographed in a dark state and having recorded therein position information indicating the position of the fixed pattern noise are obtained. The position of each pixel indicating a color information value equal to or greater than a threshold value is extracted from the noise image and the color information at the pixel at the corresponding position in the target image is substituted with a median value of color information values at surrounding pixels so as to eliminate the fixed pattern noise from the target image.

### INCORPORATION BY REFERENCE

The disclosure of the following priority application is herein incorporated by reference: Japanese Patent Application No. 2003-344319 filed Oct. 2, 2003.

### BACKGROUND OF THE INVENTION

1. Field of the Invention

The present invention relates to a noise removal technology to be adopted to remove fixed pattern noise from an image photographed by using an image-capturing apparatus.

2. Description of the Related Art

It is known that fixed pattern noise is caused by a dark current at a CCD in a digital camera. There is an image-capturing apparatus that removes such fixed pattern noise by photographing a dark image with a CCD driven with no signal light and detecting the position and the level of the fixed pattern noise in the dark image (see Japanese Laid Open Patent Publication No. H 6-197285). This apparatus removes the fixed pattern noise by subtracting the fixed pattern noise component from a photographed image based upon information related to the detected fixed pattern noise.

However, since the level of the fixed pattern noise changes in correspondence to the length of time over which the CCD is driven, the level of the fixed pattern noise in the photographed image and the level of the fixed pattern noise in the dark image do not necessarily match. The correct color information value for the photographed image cannot be obtained by subtracting the fixed pattern noise component in the dark image from the photographed image if the fixed pattern noise levels in the two images do not match. In addition, under conditions in which the sum of the color information value inherent to a given photographed image containing fixed pattern noise and the color information value corresponding to the superimposed fixed pattern noise exceeds the maximum value set for the color information value, the color information value of the photographed image is clipped at the data maximum value. In such a case, too, the color information value obtained by subtracting the fixed pattern noise component in the dark image from the photographed image does not match the correct color information value inherent to the photographed image. Thus, the fixed pattern noise cannot always be removed properly and new noise may manifest in the image having undergone the removal process when the method in which the fixed pattern noise component detected in the dark image is subtracted from the data of the photographed image is adopted.

### SUMMARY OF THE INVENTION

Through the noise removal method according to the present invention, fixed pattern noise is removed from a target image by obtaining the target image that is constituted with a plurality of pixels holding color information and contains fixed pattern noise, obtaining a noise image constituted with a plurality of pixels holding color information and having recorded therein position information indicating positions of the fixed pattern noise, extracting a position of each pixel holding color information indicating a value equal to or greater than a threshold value among the pixels constituting the noise image and replacing the color information at the subject pixel at the extracted position with color information at pixels positioned around the subject pixel.

In the noise removal method, the noise image is photographed in a dark state achieved by keeping the shutter of the image-capturing apparatus closed.

Through the noise removal method according to the present invention, fixed pattern noise can be removed from a target image by obtaining a reference image that is constituted with a plurality of pixels holding color information and is photographed under conditions that do not allow the photographed image to contain any fixed pattern noise, obtaining a target image that is constituted with a plurality of pixels holding color information, is photographed over a greater length of exposure time than at least an exposure time over which the reference image is photographed, and contains fixed pattern noise, correcting the reference image in correspondence to a brightness level of the target image, calculating a difference between a color information value at a pixel constituting the corrected reference image and a color information value at a pixel constituting the target image for each pair of pixels having matching coordinates, extracting positions of pixels manifesting a difference represented by values equal to or greater than a threshold value and substituting color information at a subject pixel at an extracted position among the pixels constituting the target image with color information located at pixels surrounding the subject pixel.

In the noise removal method, a single value can be selected as the threshold value from a plurality of different values prepared in advance.

To remove the fixed pattern noise, median filter processing may be executed by substituting the value indicated with the color information at the subject pixel with a median value of color information values at pixels surrounding the subject pixel and holding color information corresponding to a color component matching the color component at the subject pixel.

The reference image may be corrected by executing gradation processing through which the color information value at each of the pixels constituting the reference image is changed based upon lengths of exposure time over which the target image and the reference image are photographed. The reference image can be obtained by photographing a subject identical to a subject of the target image over a specific length of exposure time so as to achieve correct exposure.

A storage medium according to the present invention stores therein a noise removal processing program used to implement the noise removal method described above.

A noise removing apparatus according to the present invention includes a target image obtaining device that obtains a target image constituted with a plurality of pixels holding color information and containing fixed pattern noise, a noise image obtaining device that obtains a noise image constituted with a plurality of pixels holding color information and having recorded therein position information indicating positions of the fixed pattern noise, a noise position extracting device that makes a decision as to whether or not a value indicated in the color information at each of the pixels constituting the noise image is equal to or greater than a threshold value and extracts positions of pixels indicating color information values equal to or greater than the threshold value and a processing device that eliminates the fixed pattern noise by substituting the color information at a subject pixel located at a position extracted by the noise position extracting device among the pixels constituting the target image with color information at pixels surrounding the subject pixel.

A noise removing apparatus according to the present invention includes a reference image obtaining device that obtains a reference image constituted with a plurality of pixels holding color information and photographed under conditions that do not allow the photographed image to contain any fixed pattern noise, a target image obtaining device that obtains a target image constituted with a plurality of pixels holding color information, photographed over a greater length of exposure time than at least an exposure time over which the reference image is photographed and containing the fixed pattern noise, a reference image correcting device that corrects the reference image in correspondence to a brightness level of the target image, a difference calculating device that calculates a difference between a color information value indicated at pixels constituting the image having been corrected by the reference image correcting device and a color information value at a pixel constituting the target image for each pair of pixels having matching coordinates, a noise position extracting device that makes a decision as to whether or not a value representing the difference calculated by the difference calculating device is equal to or greater than a threshold value and extracts positions of pixels manifesting differences represented by values equal to or greater than the threshold value and a processing device that eliminates the fixed pattern noise by substituting the color information at a subject pixel located at a position extracted by the noise position extracting device among the pixels constituting the target image with color information at pixels surrounding the subject pixel.

### BRIEF DESCRIPTION OF THE DRAWINGS

FIG. 1 is a block diagram of a first embodiment achieved by adopting the noise removal method according to the present invention in an image-capturing apparatus;

FIG. 2 presents a flowchart of the processing executed in the first embodiment to remove fixed pattern noise;

FIG. 3 is a diagram provided to facilitate an explanation of the 5×5 median filter processing; and

FIG. 4 presents a flowchart of the processing executed in a second embodiment to remove fixed pattern noise.

### DETAILED DESCRIPTION OF THE PREFERRED EMBODIMENTS

### First Embodiment

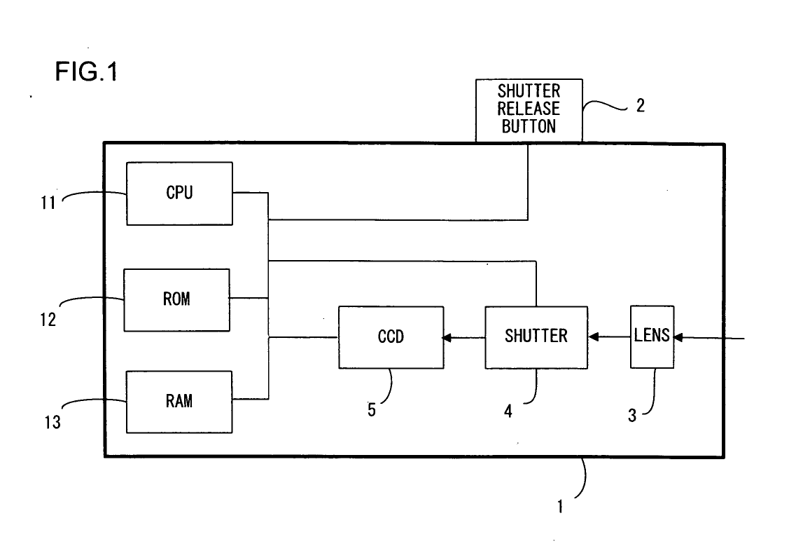

FIG. 1 is a block diagram of the first embodiment achieved by adopting the noise removal method according to the present invention in an image-capturing apparatus. In this image-capturing apparatus, the position of fixed pattern noise in a dark image photographed without any signal light is first extracted. Then, the fixed pattern noise in a target photographed image is removed by correcting a pixel at the extracted position with data at surrounding pixels. The image-capturing apparatus 1 includes a shutter release button 2, a lens 3, a shutter 4, a CCD 5, a CPU 11, a ROM 12 and a RAM 13.

As the shutter release button 2 is pressed, the CPU 11 photographs via the lens 3 an image to undergo fixed pattern noise removal (hereafter referred to as a target image) by controlling the shutter 4 and the CCD 5. Fixed pattern noise is superimposed on this target image at the CCD 5. In addition, an image (hereafter referred to as a noise image) is also photographed at this time by driving the CCD 5 in a dark state achieved with the shutter 4 closed over a length of exposure time equal to the length of exposure time during which the target image is photographed in the embodiment. Fixed pattern noise is superimposed on the noise image as well at positions matching the positions of the fixed pattern noise in the target image. Thus, the fixed pattern noise alone is recorded in the noise image. These images thus photographed are each converted to digital signals constituted of color information corresponding to a single pixel and are output from the CCD 5 to be stored into the RAM 13. The CPU 11 executes a program stored in the ROM 12 on the target image and the noise image by using the RAM 13 as a work area.

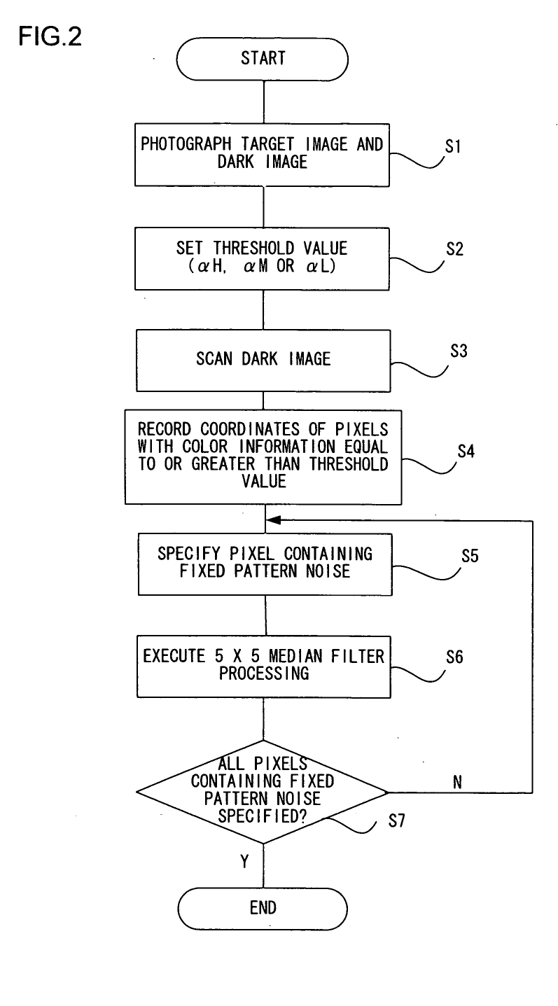

FIG. 2 presents a flowchart of the processing executed in the first embodiment to remove the fixed pattern noise. This flowchart indicates the flow of the processing executed by the CPU 11 based upon the program stored in the ROM 12. As the user presses down the shutter release button 2, the CPU 11 starts the processing.

In step S1, the target image and the noise image explained earlier are photographed and the image data are stored into the RAM 13. Each set of image data expresses the corresponding image with a combination of the value indicated in color information representing a color component R (red), G (green) or B (blue) held at each pixel and the coordinate values of the pixel. These image data are used in various types of processing executed on the target image and the noise image as explained below.

It is to be noted that while a given pixel in the photographed image data only contains color information corresponding to a single color component R, G or B when the image data are output from the CCD 5, the CPU 11 executes interpolation processing on the color information in units of individual pixels and thus each pixel comes to hold color information corresponding to all the color components R, G and B. However, the embodiment is explained by assuming that such interpolation processing is not executed on the image data and that the pixels each hold color information corresponding to a single color component R, G or B.

In step S2, a threshold value to be used to judge whether fixed pattern noise is contained in the target image is set. One of three values αH, αM and αL is set for this threshold value in correspondence to the image quality selected by the user with an operating member (not shown) or the like. In this case, αH is set in correspondence to a high image quality, αM is set in correspondence to a medium image quality and αL is set in correspondence to a low image quality. In order to ensure that the fixed pattern noise is removed to a greater extent at a higher image quality setting, the threshold value is lowered when the higher image quality is selected. For instance, the values of 128, 512 and 1024 respectively may be set for αH, αM and αL. αH, αM and αL from which the selection is made in this step are each a color information value represented in 10-bit (0-1024) data. By setting a threshold value among several threshold values for the fixed pattern noise decision-making and thus varying the number of fixed pattern noise data sets to be removed in correspondence to the image quality selected by the user, the length of processing time can be adjusted.

In step S3, individual pixels constituting the noise image read in step S1 are sequentially scanned and a decision is made as to whether or not the color information value at each pixel is equal to or greater than the threshold value set in step S2. If it is decided that the color information value is equal to or greater than the threshold value, the operation proceeds to step S4 by judging that fixed pattern noise is contained in the particular pixel. In step S4, the positions (the coordinates) of pixels with the color information values equal to or greater than the threshold value are extracted. At this time, a value A(i, j) is assigned as indicated below in expression (1) and is stored in memory for each pixel, A(i, j) with i and j representing the coordinates of the pixel in the overall image along the horizontal axis and the vertical axis respectively. As a result, it is possible to ascertain the exact coordinates of pixels containing fixed pattern noise.

$$\begin{matrix}A ( i , j ) = 1 ( when equal to or greater than the threshold value ) \\ = 0 ( when less than the threshold value )\end{matrix} \qquad ( 1 )$$

In step S5, one of the pixels located at positions matching the positions extracted in step S4 among the pixels constituting the target image read in step S1 is specified. For instance, let us assume that A(i1, j1)=1 at coordinates (i1, j1) among the values of A(i, j) at the coordinates of the individual pixels stored in step S4. In this situation, the pixel at the coordinates (i1, j1) in the target image is specified in step S5. In addition, if A(i2, j2)=1 is true at coordinates (i2, j2) as well, either the pixel at the coordinates (i1, j1) or the pixel at the coordinates (i2, j2) is specified in step S5. It is to be noted that once a pixel is specified in step S5, the same pixel is not specified again when step S5 is executed again subsequently.

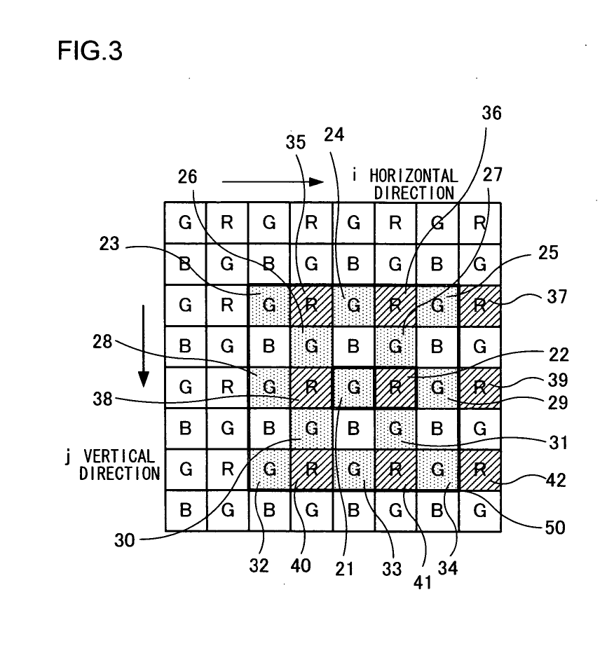

In step S6, 5×5 median filter processing is executed on the pixel specified in step 5. This processing is now explained in reference to FIG. 3. FIG. 3 shows a portion of the target image enlarged to an extent at which the individual pixels can be distinguished. It is assumed that the target image has been photographed with a single-plate CCD 5 adopting an RGB Bayer array. The letters R, G and B in FIG. 3 indicate the specific color components R (red), G (green) and B (blue) corresponding to the color information held at the individual pixels arranged in a lattice array.

Let us now assume that the pixel at the position indicated by reference numeral 21 is the pixel (subject pixel) specified in step S5. Under the circumstances described above, the color information at the subject pixel 21 contains fixed pattern noise. The 5×5 median filter processing is executed on this subject pixel 21. Namely, the median value of the color information values at the pixels holding color information corresponding to the same color component as that at the subject pixel 21 among the pixels located within the 5×5 pixel range (the range indicated by reference numeral 50) around the subject pixel 21 is calculated. As the subject pixel 21 holds color information corresponding to the G (green) component in this example, the median value of the color information values at pixels assigned with reference numerals 23 to 34 which are indicated with the halftone dot meshes in the figure is calculated. It is to be noted that the color information median value is calculated without including the color information value at the subject pixel 21.

The color information median value of the surrounding pixels calculated as described above is then used as a substitute for the color information value at the subject pixel 21. As long as fewer than half of the surrounding pixels 23 to 34 hold color information containing fixed pattern noise, i.e., as long as five or fewer pixels among the 12 surrounding pixels contain fixed pattern noise, the calculated median value is not affected by the fixed pattern noise. Thus, the fixed pattern noise contained in the color information at the subject pixel 21 is eliminated by substituting the color information value at the subject pixel 21 with the color information median value of the surrounding pixels.

Fixed pattern noise manifests at a greater number of pixels as the exposure time becomes longer and as the temperature rises. However, the number of pixels at which fixed pattern noise that will affect the image quality manifests is not large in an image photographed under normal conditions, i.e., the length of exposure time and the temperature, at which the image-capturing apparatus 1 is normally operated. Namely, among the surrounding pixels used for the substitution processing described above, fewer than half of them are likely to contain fixed pattern noise. For this reason, the median value calculated based upon the color information values at the surrounding pixels is not affected by the fixed pattern noise and thus, the fixed pattern noise at the subject pixel 21 can be eliminated through the substitution processing described above.

When the subject pixel holds color information corresponding to the G (green) component, the color information value at the subject pixel is substituted with the median value of the color information values at the 12 pixels surrounding the subject pixel, as described above. However, if the subject pixel holds color information corresponding to the R (red) color component or the B (blue) color component, the number of surrounding pixels the color information of which is used to calculate the color information median value becomes different depending upon the particulars of the pixel arrangement. For instance, when the subject pixel is the pixel assigned with reference numeral 22, which holds color information corresponding to the R (red) color component, the median value is calculated by using the color information values at the eight surrounding pixels assigned with reference numerals 35 to 42. The color information value at the subject pixel 22 is substituted with the median value calculated by using the color information at the eight surrounding pixels in this case. In addition, when the subject pixel holds color information corresponding to the B (blue) component, too, the median value is calculated by using the color information values at the eight surrounding pixels, as described above, as in the case of the subject pixel holding R (red) color information.

The fixed pattern noise contained in the color information at the subject pixel specified in step S5 is removed through the 5×5 median filter processing executed in step S6, as explained above.

In step S7 following step S6, a decision is made as to whether or not all the pixels in the target image at the positions matching the positions of the pixels determined to indicate values equal to or greater than the threshold value in step S3 have been specified in step S5. The processing ends if it is judged that all the pixels have been specified. If, on the other hand, it is judged that not all the pixels have been specified yet, the operation returns to step S5 to repeatedly execute the processing described above.

The following advantages are achieved by adopting the image-capturing apparatus in the first embodiment.
(1) Since fixed pattern noise at a subject pixel is eliminated by substituting the color information at the subject pixel with color information at surrounding pixels, the fixed pattern noise in the target image can be removed with a high degree of effectiveness.
(2) Since a variable threshold value is used when making a decision as to whether or not fixed pattern noise is contained in the image, the number of pixels from which the fixed pattern noise is eliminated can be adjusted. As a result, the length of time required to execute the processing for fixed pattern noise removal can be adjusted.
(3) Since the color information at the subject pixel is substituted with color information at surrounding pixels through the median filter processing, visually natural color is obtained in the image having undergone the fixed pattern noise removal processing.
(4) Since the positions of pixels containing fixed pattern noise are extracted by using an image photographed in a dark state, the positions of all the pixels containing fixed pattern noise can be extracted through the processing executed on a single image and thus, the length of processing time can be reduced.

### Second Embodiment

The second embodiment achieved by adopting the noise removal method according to the present invention in an image-capturing apparatus is explained below. In place of the noise image used in the first embodiment, an image (hereafter referred to as a reference image) photographed over a shorter length of exposure time and having recorded therein no fixed pattern noise is used in the image-capturing apparatus in the second embodiment. An image is obtained by correcting the reference image and the positions of the fixed pattern noise are extracted by calculating the difference between the color information in this image and the color information in the target image in the second embodiment. It is to be noted that since the image-capturing apparatus in the second embodiment adopts a structure identical to that of the image-capturing apparatus in the first embodiment, its illustration is omitted.

As explained earlier, fixed pattern noise manifests at a greater number of pixels as the exposure time lengthens. Accordingly, by setting the length of exposure time to a value equal to or smaller than a predetermined value and thus reducing the length of time over which the CCD 5 is driven, a reference image that does not contain any fixed pattern noise can be photographed. Namely, by photographing the same subject as that in the target image containing the fixed pattern noise over the exposure time set to a value equal to or less than the predetermined value and comparing the reference image thus photographed with the target image, position information indicating the positions of the fixed pattern noise can be obtained under conditions closer to the photographing conditions in which the target image is photographed. Since a reference image photographed in this manner does not achieve a sufficient level of brightness, its brightness is corrected in correspondence to that of the target image so as to make possible comparison of the reference image with the target image.

It is to be noted that if the length of exposure time, i.e., the length of time over which the CCD 5 is driven, is reduced to an excessive extent when photographing the reference image, the photographed image will not even achieve a level of brightness that will allow it to be corrected in correspondence to the brightness level of the target image. For this reason, the length of exposure time over which the reference image is photographed should be determined so as to satisfy a relationship ascertained by conducting various types of tests based upon the length of exposure time over which the target image is photographed.

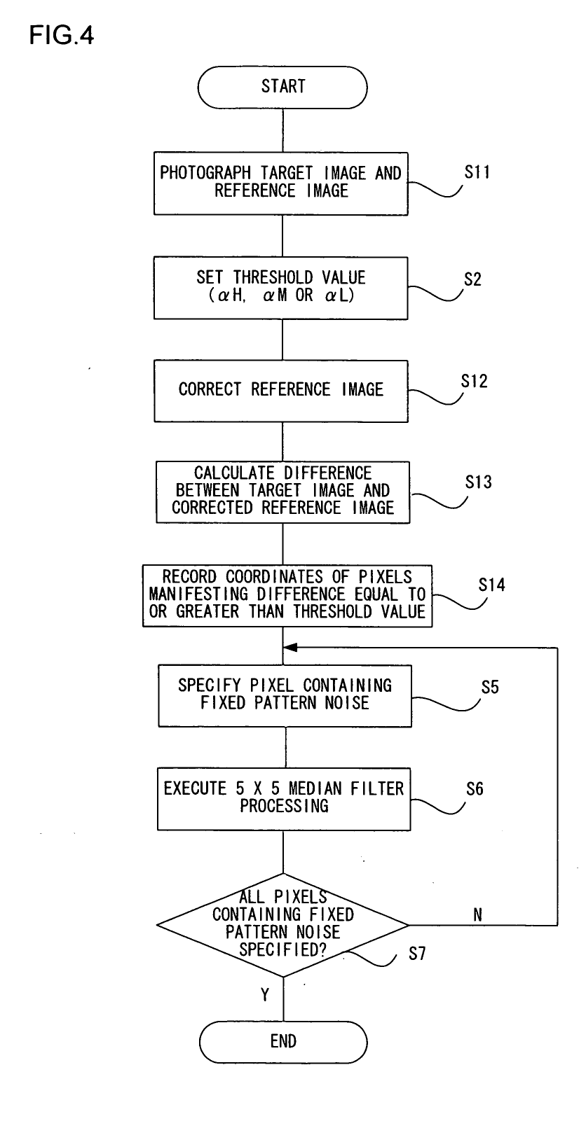

FIG. 4 presents a flowchart of the processing executed in the second embodiment for fixed pattern noise removal. This flowchart indicates the flow of the processing executed by the CPU 11 in conformance to the program stored in the ROM 12 as in the first embodiment. As the user presses down the shutter release button 2, the CPU 11 starts the processing. It is to be noted that the same step numbers are assigned to steps in which processing identical to that in the flowchart in FIG. 2 is executed so as to preclude the necessity for a detailed explanation thereof.

In step S11, the target image and the reference image explained earlier are photographed and these image data are stored into the RAM 13. As described earlier, the reference image is obtained by photographing the same subject as that in the target image over the exposure time the length of which is determined based upon the length of exposure time over which the target image is photographed. It is to be noted that the image data of the reference image, too, express the image with a combination of the value corresponding to the R, G or B color component at each pixel and the coordinate values of the pixel as do the image data of the target image. It is assumed that each pixel holds color information corresponding to a single color component, R, G or B.

In step S2, processing identical to that in the first embodiment is executed to set the threshold value to be used in the fixed pattern noise decision-making.

In step S12 following step S2, the reference image is corrected in correspondence to the level of brightness of the target image. The reference image is corrected by executing gradation processing through which the color information value at each pixel is changed to a specific value based upon a reference table stored in the ROM 12. A plurality of reference tables are stored in correspondence to varying lengths of exposure time at the ROM 12, and a specific reference table to be used is determined based upon the lengths of exposure time over which the target image and the reference image are photographed. It is to be noted that values determined by conducting various tests and the like are set at the reference tables.

In step S13, the difference between the color information value at each of the pixels constituting the target image photographed in step S11 and the color information value at the corresponding pixel at the same coordinates in the reference image corrected in step S12 is calculated. In addition, a decision is made for each pixels as to whether or not the value representing the difference having been calculated is equal to or greater than the threshold value set in step S2. If the value representing the difference is equal to or greater than the threshold value, the operation proceeds to step S14 by judging that fixed pattern noise is contained at the pixel located at the coordinate position in the subject image. In step S14, the position (coordinates) of each pixel manifesting a difference equal to or greater than the threshold value is extracted. At this time, the value assigned to A (i, j) as indicated in expression (1) is stored in memory for each pixel, as in the first embodiment. As a result, it is possible to determine whether or not the color information value at each pixel is equal to or greater than the threshold value.

The processing executed in step S5 and subsequent steps is identical to the processing executed in step S5 and subsequent steps in the flowchart presented in FIG. 2. It is assumed that among the surrounding pixels 23 to 34 in FIG. 3, only half or fewer pixels contain fixed pattern noise and thus, the median value calculated by using the color information at the surrounding pixels does not contain fixed pattern noise, as in the first embodiment. Under such circumstances, by executing the 5×5 median filter processing in step S6 on the pixel specified in step S5 while repeatedly executing the processing in steps S5 through S7, fixed pattern noise is removed from the target image.

The image-capturing apparatus in the second embodiment photographs a reference image that does not contain any fixed pattern noise and extracts the position of each pixel containing fixed pattern noise based upon the difference between the color information value in the target image and the color information value in the reference image. The reference image is obtained by photographing the same subject as the subject in the target image over a shorter exposure time than the exposure time over which the target image is photographed. As a result, in addition to the advantages of the image-capturing apparatus achieved in the first embodiment, another advantage is obtained in that fixed pattern noise can be removed under conditions even closer to the photographing conditions in which the target image is photographed.

The above described embodiments are examples, and various modifications can be made without departing from the spirit and scope of the invention. For instance, while an explanation is given on an example in which the 5×5 median filter processing is executed in order to remove fixed pattern noise, median filter processing may be executed by using an arbitrary number of pixels surrounding the subject pixel.

While one of the three different values is set as the threshold value to be used in the fixed pattern noise decision-making in correspondence to the image quality setting selected by the user in the embodiments described above, the present invention is not limited to this example either. For instance, the number of threshold values may be arbitrary. In addition, the threshold value may be automatically set based upon the color information in the noise image or the color information calculated by using the target image and the reference image so that a constant number of pixels is determined to contain fixed pattern noise.

While an explanation is given above in reference to the embodiments on an example in which each set of image data is constituted of pixels arranged in an RGB Bayer array, the present invention may be adopted in conjunction with image data adopting another calorimetric system or image data held at pixels arranged in another pixel array. In addition, the present invention may be adopted in conjunction with image data with each pixel holding color information corresponding to a plurality of color components as well.

While an explanation is given above in reference to the embodiments on an example in which the CPU 11 in the image-capturing apparatus 1 executes fixed pattern noise removal processing, the present invention is not limited to this example. For instance, a noise removing apparatus having installed therein such a processing program may be utilized to process images taken in from an image-capturing apparatus, or the processing program may be installed in a personal computer. Namely, the present invention may be adopted in all types of apparatuses that execute processing by taking in image data. Accordingly, the present invention may be adopted in a digital still camera or in a digital video camera as well.

1. A noise removal method for removing fixed pattern noise from an image photographed with an image-capturing apparatus, comprising steps for:
obtaining a target image that is constituted with a plurality of pixels holding color information and contains fixed pattern noise;
obtaining a noise image that is constituted with a plurality of pixels holding color information and has recorded therein position information indicating positions of the fixed pattern noise;
making a decision as to whether or not a color information value at each of the pixels constituting the noise image is equal to or greater than a threshold value and extracting positions of pixels indicating color information values equal to or greater than the threshold value; and
removing fixed pattern noise by substituting the color information at a subject pixel at an extracted position among the pixels constituting the target image with color information at pixels surrounding the subject pixel.

2. A noise removal method according to claim 1, wherein:
a single value is selected as the threshold value from a plurality of different values prepared in advance.

3. A noise removal method according to claim 1, wherein:
median filter processing is executed to remove the fixed pattern noise by substituting the value indicated with the color information at the subject pixel with a median value of color information values at pixels surrounding the subject pixel and holding color information corresponding to a color component matching the color component at the subject pixel.

4. A noise removal method according to claim 1, wherein:
the noise image is photographed in a dark state achieved by keeping the shutter of the image-capturing apparatus closed.

5. A noise removal method for removing fixed pattern noise from an image photographed with an image-capturing apparatus, comprising steps for:
obtaining a reference image that is constituted with a plurality of pixels holding color information and is photographed under conditions that do not allow the photographed image to contain any fixed pattern noise;
obtaining a target image that is constituted with a plurality of pixels holding color information, is photographed over a greater length of exposure time than at least an exposure time over which the reference image is photographed, and contains fixed pattern noise;
correcting the reference image in correspondence to a brightness level of the target image;
calculating a difference between a color information value at a pixel constituting the corrected reference image and a color information value at a pixel constituting the target image for each pair of pixels having matching coordinates;
extracting positions of pixels manifesting the difference represented by values equal to or greater than a threshold value; and
removing fixed pattern noise by substituting color information at a subject pixel at an extracted position among the pixels constituting the target image with color information located at pixels surrounding the subject pixel.

6. A noise removal method according to claim 5, wherein:
a single value is selected as the threshold value from a plurality of different values prepared in advance.

7. A noise removal method according to claim 5, wherein:
median filter processing is executed to remove the fixed pattern noise by substituting the value indicated with the color information at the subject pixel with a median value of color information values at pixels surrounding the subject pixel and holding color information corresponding to a color component matching the color component at the subject pixel.

8. A noise removal method according to claim 5, wherein:
the reference image is corrected by executing gradation processing through which the color information value at each of the pixels constituting the reference image is changed based upon lengths of exposure time over which the target image and the reference image are photographed.

9. A noise removal method according to claim 5, wherein:
the reference image is obtained by photographing a subject identical to a subject of the target image over a specific length of exposure time so as to achieve correct exposure.

10. A storage medium having stored therein a noise removal processing program used to implement a noise removal method according to claim 1.

11. A noise removing apparatus used to eliminate fixed pattern noise from an image photographed with an image-capturing apparatus, comprising:
a target image obtaining device that obtains a target image constituted with a plurality of pixels holding color information and containing fixed pattern noise;
a noise image obtaining device that obtains a noise image constituted with a plurality of pixels holding color information and having recorded therein position information indicating positions of the fixed pattern noise;
a noise position extracting device that makes a decision as to whether or not a value indicated in the color information at each of the pixels constituting the noise image is equal to or greater than a threshold value and extracts positions of pixels indicating color information values equal to or greater than the threshold value; and
a processing device that eliminates the fixed pattern noise by substituting the color information at a subject pixel located at a position extracted by the noise position extracting device among the pixels constituting the target image with color information at pixels surrounding the subject pixel.

12. A noise removing apparatus used to eliminate fixed pattern noise from an image photographed with an image-capturing apparatus comprising:
a reference image obtaining device that obtains a reference image constituted with a plurality of pixels holding color information and photographed under conditions that do not allow the photographed image to contain any fixed pattern noise;
a target image obtaining device that obtains a target image constituted with a plurality of pixels holding color information, photographed over a greater length of exposure time than at least an exposure time over which the reference image is photographed and containing the fixed pattern noise;
a reference image correcting device that corrects the reference image in correspondence to a brightness level of the target image;
a difference calculating device that calculates a difference between a color information value indicated at pixels constituting the image having been corrected by the reference image correcting device and a color information value at a pixel constituting the target image for each pair of pixels having matching coordinates;
a noise position extracting device that makes a decision as to whether or not a value representing the difference calculated by the difference calculating device is equal to or greater than a threshold value and extracts positions of pixels manifesting differences represented by values equal to or greater than the threshold value; and
a processing device that eliminates the fixed pattern noise by substituting the color information at a subject pixel located at a position extracted by the noise position extracting device among the pixels constituting the target image with color information at pixels surrounding the subject pixel.

13. A storage medium having stored therein a noise removal processing program used to implement a noise removal method according to claim 2.

14. A storage medium having stored therein a noise removal processing program used to implement a noise removal method according to claim 3.

15. A storage medium having stored therein a noise removal processing program used to implement a noise removal method according to claim 4.

16. A storage medium having stored therein a noise removal processing program used to implement a noise removal method according to claim 5.

17. A storage medium having stored therein a noise removal processing program used to implement a noise removal method according to claim 6.

18. A storage medium having stored therein a noise removal processing program used to implement a noise removal method according to claim 7.

19. A storage medium having stored therein a noise removal processing program used to implement a noise removal method according to claim 8.

20. A storage medium having stored therein a noise removal processing program used to implement a noise removal method according to claim 9.
